(19) United States
(12) Patent Application Publication
(10) Pub. No.: US 2023/0362451 A1
(43) Pub. Date: Nov. 9, 2023

(54) GENERATION OF CLOSED CAPTIONS BASED ON VARIOUS VISUAL AND NON-VISUAL ELEMENTS IN CONTENT

(71) Applicant: SONY GROUP CORPORATION, TOKYO (JP)

(72) Inventors: BRANT CANDELORE, POWAY, CA (US); ADAM GOLDBERG, FAIRFAX, VA (US); ROBERT BLANCHARD, ST. GEORGE, UT (US)

(21) Appl. No.: 17/739,253

(22) Filed: May 9, 2022

(51) Int. Cl. G10L 15/26; H04N 21/488; H04N 21/45; G10L 15/25

(52) U.S. Cl. CPC H04N 21/4884; G10L 15/25; G10L 15/26; H04N 21/4532

(57) ABSTRACT

An electronic device and method for generation of closed captions based on various visual and non-visual elements in content is disclosed. The electronic device receives media content including video content and audio content associated with the video content. The electronic device generates a first text based on a speech-to-text analysis of the audio content. The electronic device further generates a second text which describes audio elements of a scene associated with the media content. The audio elements are different from a speech component of the audio content. The electronic device further generates closed captions for the video content, based on the first text and the second text and controls a display device to display the closed captions.

### CROSS-REFERENCE TO RELATED APPLICATIONS/INCORPORATION BY REFERENCE

None

### FIELD

Various embodiments of the disclosure relate to generation of closed captions. More specifically, various embodiments of the disclosure relate to an electronic device and method for generation of closed captions based on various visual and non-visual elements in content.

### BACKGROUND

Advancements in accessibility technology and content streaming have led to an increase in use of subtitles and closed captions in on-demand content and linear television programs. Captions may be utilized by users, especially ones with a hearing disability to understand dialogues and scenes in a video. Typically, captions may be generated at the video source and embedded into the video stream. Alternatively, the captions, especially for live content, can be generated based on a suitable automatic speech recognition (ASR) for a speech-to-text conversion of an audio segment of the video. However, such captions may not always be flawless, especially if the audio is recorded in a noisy environment or if people in the video don’t enunciate properly. For example, people can have a non-native or a heavy accent that can be difficult to process by a traditional speech-to-text conversion model. In addition, the background noises, e.g., that music is playing or baby crying, are left out. In relation to accessibility, users with a hearing disability may not always be satisfied by the conventionally generated captions.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

An electronic device and method for generation of closed captions based on various visual and non-visual elements in content is provided substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram that illustrates an exemplary network environment for generation of closed captions based on various visual and non-visual elements in content, in accordance with an embodiment of the disclosure.

FIG. 2 is a block diagram that illustrates an exemplary electronic device of FIG. 1, in accordance with an embodiment of the disclosure.

FIG. 3 is a diagram that illustrates an exemplary processing pipeline for generation of closed captions based on various visual and non-visual elements in content, in accordance with an embodiment of the disclosure.

FIG. 4A is a diagram that illustrates an exemplary scenario for generation of closed captions based on various visual and non-visual elements in content, in accordance with an embodiment of the disclosure.

FIG. 4B is a diagram that illustrates an exemplary scenario for generation of closed captions based on various visual and non-visual elements in content, in accordance with an embodiment of the disclosure.

FIG. 4C is a diagram that illustrates an exemplary scenario for generation of closed captions based on various visual and non-visual elements in content, in accordance with an embodiment of the disclosure.

FIG. 5 is a diagram that illustrates an exemplary scenario for generation of closed captions when a portion of audio content is unintelligible, in accordance with an embodiment of the disclosure.

FIG. 6 is a diagram that illustrates an exemplary scenario for generation of hand-sign symbols based on various visual and non-visual elements in content, in accordance with an embodiment of the disclosure.

FIG. 7 is a flowchart that illustrates exemplary operations for generation of closed captions based on various visual and non-visual elements in content, in accordance with an embodiment of the disclosure.

### DETAILED DESCRIPTION

The following described implementation may be found in the disclosed electronic device and method for generation of closed captions based on various visual and non-visual elements in content. Exemplary aspects of the disclosure provide an electronic device, which may automatically generate captions (such as closed captions and hand-sign symbols associated with a sign language) based on visual and non-visual elements in media content. The electronic device may be configured to receive media content, including video content and audio content associated with the video content. The received media content may be a pre-recorded media content or a live media content. The electronic device may be configured to generate a first text based on a speech-to-text analysis of the audio content. In an embodiment, the first text may be generated further based on an analysis of lip movements in the video content.

The electronic device may be configured to generate a second text which describes one or more audio elements of a scene associated with the media content. The one or more audio elements may be different from a speech component of the audio content. For example, that music is playing or a baby in crying. The electronic device may be configured to generate closed captions for the video content, based on the generated first text and the generated second text. Thereafter, the electronic device may be configured to control a display device associated with the electronic device, to display the generated closed captions.

While the disclosed electronic device generates a first text based on the speech-to-text analysis and/or lip movement analysis of the media content, the disclosed electronic device may use an Al model to analyze the audio and video content and generate a second text based on the analysis of various audio elements of the media content. By combining both the first text and the second text in the captions, the disclosed electronic device may provide captions that enrich the spoken text (i.e., the first text) and provide contextual information about various audio elements that are typically observed by full-hearing viewers but not included in auto-generated captions.

To aid users with a hearing disability, the disclosed electronic device may generate captions that include hand-sign symbols in a specific sign language (such as American Sign Language). Such symbols may be a representation of the captions generated based on the first text and the second text. To further help users with a hearing disability or intelligibility issues, the disclosed electronic device may be configured to determine a portion of the audio content as unintelligible based on at least one of, but not limited to, a determination that the portion of the audio content is missing a sound, a determination that the speech-to-text analysis has failed to interpret speech in the audio content to a threshold level of certainty, a hearing disability or a hearing loss of a user associated with the electronic device, an accent of a speaker associated with the portion of the audio content, a loud sound or a noise in a background of an environment that includes the electronic device, a determination that the electronic device is on mute, an inability of the user to hear sound at certain frequencies, and a determination that the portion of the audio content is noisy. Based on the determination that the portion of the audio content is unintelligible; the electronic device may be configured to generate the closed captions.

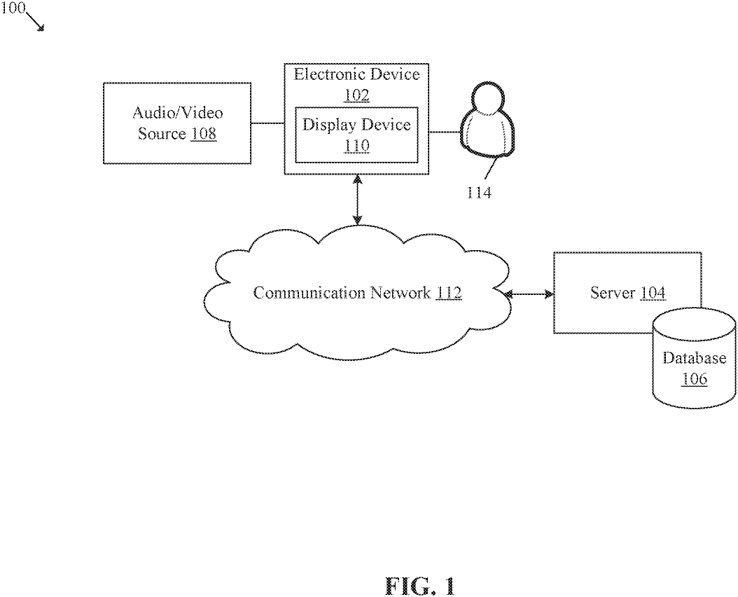

FIG. 1 is a block diagram that illustrates an exemplary network environment for generation of closed captions based on various visual and non-visual elements in content, in accordance with an embodiment of the disclosure. With reference to FIG. 1, there is shown a network environment 100. The network environment 100 may include an electronic device 102, a server 104, a database 106, and an audio/video (AV) source 108. The electronic device 102 may further include a display device 110. The electronic device 102 and the server 104 may be communicatively coupled with each other, via a communication network 112. In the network environment 100, there is further shown a user 114 associated with the electronic device 102.

The electronic device 102 may include suitable logic, circuitry, interfaces, and/or code that may be configured to receive media content from the AV source 108 and generate closed captions based on various visual and non-visual elements in the media content.

In an exemplary embodiment, the electronic device 102 may be a display-enabled media player and the display device 110 may be included in the electronic device 102. Examples of such an implementation of the electronic device 102 may include, but are not limited to, a television (TV), an Internet-Protocol TV (IPTV), a smart TV, a smartphone, a personal computer, a laptop, a tablet, a wearable electronic device, or any other display device with a capability to receive, decode, and play content encapsulated in broadcasting signals from cable or satellite networks, over-the-air broadcast, or internet-based communication signals.

In another exemplary embodiment, the electronic device 102 may be a media player that may communicate with the display device 110, via a wired or a wireless connection. Examples of such an implementation of the electronic device 102 may include, but are not limited to, a digital media player (DMP), a micro-console, a TV tuner, an Advanced Television Systems Committee (ATSC) 3.0 tuner, a set-top-box, an Over-the-Top (OTT) player, a digital media streamer, a media extender/regulator, a digital media hub, a computer workstation, a mainframe computer, a handheld computer, a smart appliance, a plug-in device, and/or any other computing device with content streaming functionality.

The server 104 may include suitable logic, circuitry, and interfaces, and/or code that may be configured to store the media content and may be used to train an Al model on a lip-reading task. In an exemplary embodiment, the server 104 may be implemented as a cloud server and may execute operations through web applications, cloud applications, HTTP requests, repository operations, file transfer, and the like. Other example implementations of the server 104 may include, but are not limited to, a database server, a file server, a content server, a web server, an application server, a mainframe server, or a cloud computing server.

In at least one embodiment, the server 104 may be implemented as a plurality of distributed cloud-based resources by use of several technologies that are well known to those ordinarily skilled in the art. A person with ordinary skill in the art will understand that the scope of the disclosure may not be limited to the implementation of the server 104 and the electronic device 102 as two separate entities. In certain embodiments, the functionalities of the server 104 may be incorporated in its entirety or at least partially in the electronic device 102, without a departure from the scope of the disclosure.

The database 106 may be configured to store hand-sign symbols associated with a sign language. The database 106 may also store a user profile associated with the user 114. The user profile may be indicative of a listening ability of the user or a viewing ability of the user. The database 106 may be stored on a server, such as the server 104 or may be cached and stored on the electronic device 102.

The AV source 108 may include suitable logic, circuitry, and interfaces that may be configured to transmit the media content to the electronic device 102. The media content on the AV source 108 may include video content and audio content associated with the video content. For example, if the media content is a television program, then the audio content may include a background audio, actor voice or speech, and other audio components, such as an audio description.

In an embodiment, the AV source 108 may be implemented as a storage device which stores the media content. Examples of such an implementation of the AV source 108 may include, but are not limited to, a Pen Drive, a Flash USB Stick, a Hard Disk Drive (HDD), a Solid-State Drive (SSD), and/or a Secure Digital (SD) card. In another embodiment, the AV source 108 may be implemented as a media streaming server, which may transmit the media content to the electronic device 102, via the communication network 112. In another embodiment, the AV source 108 may be an TV tuner, such as an ATSC tuner, which may receive digital TV (DTV) signals from an over-the-air broadcast network and may extract the media content from the received DTV signal. Thereafter, the AV source 108 may transmit the extracted media content to the electronic device 102.

In FIG. 1, the AV source 108 and the electronic device 102 are shown as two separate devices. However, the present disclosure may not be so limiting and in some embodiments, the functionality of the AV source 108 may be incorporated in its entirety or at least partially in the electronic device 102, without departing from the scope of the present disclosure.

The display device 110 may include suitable logic, circuitry, and interfaces that may be configured to display an output of the electronic device 102. The display device 110 may be utilized to display video content received from the electronic device 102. The display device 110 may be further configured to display closed captions for the video content. The display device 110 may be a unit that has be interfaced or connected with the electronic device 102, through an I/O port (such as a High-Definition Multimedia Interface (HDMI) port) or a network interface. Alternatively, the display device 110 may be an embedded component of the electronic device 102.

In at least one embodiment, the display device 110 may be a touch screen which may enable the user 114 to provide a user-input via the display device 110. The display device 110 may be realized through several known technologies such as, but not limited to, at least one of a Liquid Crystal Display (LCD) display, a foldable or rollable display, a Light Emitting Diode (LED) display, a plasma display, or an Organic LED (OLED) display technology, or other display devices. In accordance with an embodiment, the display device 110 may refer to a display screen of a head mounted device (HMD), a smart-glass device, a see-through display, a projection-based display, an electro-chromic display, or a transparent display.

The communication network 112 may include a communication medium through which the electronic device 102 and the server 104 may communicate with each other. Examples of the communication network 112 may include, but are not limited to, the Internet, a cloud network, a Wireless Local Area Network (WLAN), a Wireless Fidelity (Wi-Fi) network, a Personal Area Network (PAN), a Local Area Network (LAN), a telephone line (POTS), and/or a Metropolitan Area Network (MAN), a mobile wireless network, such as a Long-Term Evolution (LTE) network (for example, 4th Generation or 5th Generation (5G) mobile network (i.e., 5G New Radio)). Various devices in the network environment 100 may be configured to connect to the communication network 112, in accordance with various wired and wireless communication protocols. Examples of such wired and wireless communication protocols may include, but are not limited to, at least one of a Transmission Control Protocol and Internet Protocol (TCP/IP), User Datagram Protocol (UDP), Hypertext Transfer Protocol (HTTP), File Transfer Protocol (FTP), ZigBee, EDGE, IEEE 802.11, light fidelity (Li-Fi), 802.16, IEEE 802.11 s, IEEE 802.11 g, multi-hop communication, wireless access point (AP), device to device communication, cellular communication protocols, or Bluetooth (BT) communication protocols, or a combination thereof.

In operation, the electronic device 102 may receive a user input, for example, to turn-on the electronic device 102 or to activate an automated caption generation mode. In such a mode, the electronic device 102 may be configured to perform a set of operations to generate captions to be displayed along with media content. A description of such operations is described herein.

At any time-instant, the electronic device 102 may be configured to receive the media content from the AV source 108. The media content may include video content and audio content associated with the video content. The media content may be any digital data, which can be rendered, streamed, broadcasted, or stored on any electronic device or storage. Examples of the media content may include, but are not limited to, images (such as overlay graphics), animations (such as 2D/3D animations or motion graphics), audio/video data, conventional television programming (provided via traditional broadcast, cable, satellite, Internet, or other means), pay-per-view programs, on-demand programs (as in video-on-demand (VOD) systems), or Internet content (e.g., streaming media, downloadable media, Webcasts, etc.). In an embodiment, the received media content may be a pre-recorded media content or a live media content.

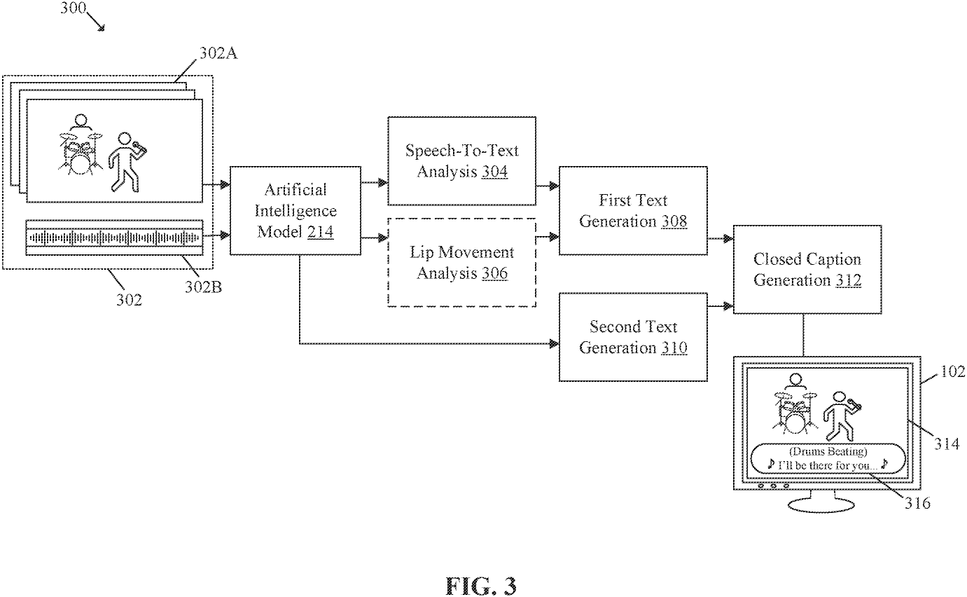

The electronic device 102 may be configured to generate a first text based on a speech-to-text analysis of the audio content. Details related to the generation of the first text are provided, for example, in FIG. 3. The electronic device 102 may be configured to further generate a second text that describes one or more audio elements of a scene associated with the media content. The audio elements may be different from a speech component of the audio content. Details related to the generation of the second text are provided, for example, in FIG. 3.

The electronic device 102 may be configured to further generate closed captions for the video content, based on the generated first text and the generated second text. For instance, the closed captions may include a textual representation or a description of various speech elements, such as spoken words or dialogues and non-speech elements such as emotions, face expressions, visual elements in scenes of the video content, or non-verbal sounds. The generation of the closed captions is described, for example, in FIG. 3. In accordance with an embodiment, to combine both the first text and the second text, the content distribution system 102 may look for gaps or inaccuracies (e.g., word or sentence predictions for which confidence is below a threshold) in the first text and may then fill the gaps or replace portions of the first text with respective portion of the second text.

The electronic device 102 may be configured to control the display device 110 to display the generated closed captions, as described, for example, in FIG. 3. By way of example, and not limitation, the closed captions may be displayed as an overlay over the video content or within a screen area of the display device 110 that may be reserved for the display of the closed captions. The display of the closed captions may be synchronized based on factors, such as scenes included in the video content, the audio content, and a playback speed and timeline of the video content. In an embodiment, the electronic device 102 may apply an AI model or a suitable content recognition model on the received media content to generate information, such as metatags or timestamps to be used to display the different components of the generated closed captions on the display device 110.

The electronic device 102 may analyze all kinds of visual and non-visual elements depicted in scenes associated with the media content. Such elements may correspond to all kinds of audio-based, video-based, or audio-visual actions or events in the scenes that any viewer may typically observe while viewing the scenes. Such elements are different from elements, such as lip movements in the media (video) content or a speech component of the media content. In an embodiment, the disclosed electronic device 102 may be configured to determine a portion of the audio content as unintelligible. For example, a speaker may have a non-native or a heavy accent that can be difficult to understand, the audio may be recorded in a noisy environment, or the speaker may not be enunciating properly. The disclosed electronic device 102 may be configured to generate optimum captions for the determined unintelligible portion of the audio content.

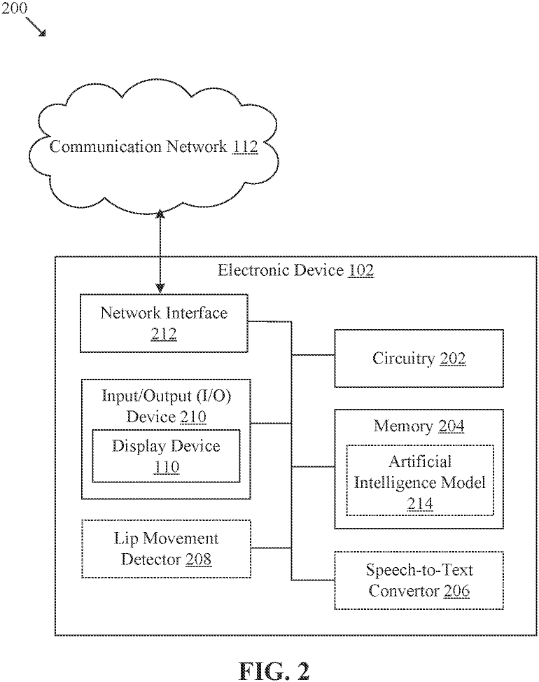

FIG. 2 is a block diagram that illustrates an exemplary electronic device of FIG. 1, in accordance with an embodiment of the disclosure. FIG. 2 is explained in conjunction with elements from FIG. 1. With reference to FIG. 2, there is shown the electronic device 102. The electronic device 102 may include circuitry 202, a memory 204, a speech-to-text convertor 206, a lip movement detector 208, an input/output (I/O) device 210, and a network interface 212. The I/O device 210 may include the display device 110. The memory 204 may include an artificial intelligence (AI) model 214. The network interface 212 may connect the electronic device 102 with the server 104 and the database 106, via the communication network 112.

The circuitry 202 may include suitable logic, circuitry, and/or interfaces that may be configured to execute program instructions associated with different operations to be executed by the electronic device 102. The circuitry 202 may include one or more processing units, which may be implemented as a separate processor. In an embodiment, the one or more processing units may be implemented as an integrated processor or a cluster of processors that perform the functions of the one or more specialized processing units, collectively. The circuitry 202 may be implemented based on a number of processor technologies known in the art. Examples of implementations of the circuitry 202 may be an X86-based processor, a Graphics Processing Unit (GPU), a Reduced Instruction Set Computing (RISC) processor, an Application-Specific Integrated Circuit (ASIC) processor, a Complex Instruction Set Computing (CISC) processor, a microcontroller, a central processing unit (CPU), and/or other control circuits.

The memory 204 may include suitable logic, circuitry, interfaces, and/or code that may be configured to store one or more instructions to be executed by the circuitry 202. The memory 204 may be configured to store the AI model 214 and the media content. The memory 204 may be further configured to store a user profile associated with the user 114. In an embodiment, the memory 204 may store hand-sign symbols associated with a sign language, such as American Sign Language (ASL). Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The AI model 214 may be trained on a task to analyze the video content and/or audio content to generate a text that describes visual elements or non-visual elements (such as non-verbal sounds) in the media content. For example, the AI model 214 may be trained to analyze lip movements in the video content to generate a first text. In an embodiment, the AI model 214 may be also trained to analyze one or more visual elements of a scene associated with the media content to generate a third text. Such elements may be different from lip movements in the video content.

In an embodiment, the AI model 214 may be implemented as a deep learning model. The deep learning model may be defined by its hyper-parameters and topology/architecture. For example, the deep learning model may be a deep neural network-based model that may have a number of nodes (or neurons), activation function(s), number of weights, a cost function, a regularization function, an input size, a learning rate, number of layers, and the like. Such a model may be referred to as a computational network or a system of nodes (for example, artificial neurons). For a deep learning implementation, the nodes of the deep learning model may be arranged in layers, as defined in a neural network topology. The layers may include an input layer, one or more hidden layers, and an output layer. Each layer may include one or more nodes (or artificial neurons, represented by circles, for example). Outputs of all nodes in the input layer may be coupled to at least one node of hidden layer(s). Similarly, inputs of each hidden layer may be coupled to outputs of at least one node in other layers of the model. Outputs of each hidden layer may be coupled to inputs of at least one node in other layers of the deep learning model. Node(s) in the final layer may receive inputs from at least one hidden layer to output a result. The number of layers and the number of nodes in each layer may be determined from the hyper-parameters, which may be set before, while, or after training the deep learning model on a training dataset.

Each node of the deep learning model may correspond to a mathematical function (e.g., a sigmoid function or a rectified linear unit) with a set of parameters, tunable during training of the model. The set of parameters may include, for example, a weight parameter, a regularization parameter, and the like. Each node may use the mathematical function to compute an output based on one or more inputs from nodes in other layer(s) (e.g., previous layer(s)) of the deep learning model. All or some of the nodes of the deep learning model may correspond to same or a different mathematical function.

In training of the deep learning model, one or more parameters of each node may be updated based on whether an output of the final layer for a given input (from the training dataset) matches a correct result based on a loss function for the deep learning model. The above process may be repeated for same or a different input till a minima of loss function is achieved, and a training error is minimized. Several methods for training are known in the art, for example, gradient descent, stochastic gradient descent, batch gradient descent, gradient boost, meta-heuristics, and the like.

In an embodiment, the AI model 214 may include electronic data, which may be implemented as, for example, a software component of an application executable on the electronic device 102. The AI model 214 may include code and routines that may be configured to enable a computing device, such as the electronic device 102 to perform one or more operations for generation of captions. Additionally, or alternatively, the AI model 214 may be implemented using hardware including, but not limited to, a processor, a microprocessor (e.g., to perform or control performance of one or more operations), a field-programmable gate array (FPGA), a co-processor (such as an Al-accelerator), or an application-specific integrated circuit (ASIC). In some embodiments, the trained AI model 214 may be implemented using a combination of both hardware and software.

In certain embodiments, the AI model 214 may be implemented based on a hybrid architecture of multiple Deep Neural Networks (DNNs). Examples of the AI model 214 may include a neural network model, such as, but are not limited to, an artificial neural network (ANN), a deep neural network (DNN), a convolutional neural network (CNN), a recurrent neural network (RNN), a CNN-recurrent neural network (CNN-RNN), R-CNN, Fast R-CNN, Faster R-CNN, a You Only Look Once (YOLO) network, a Residual Neural Network (Res-Net), a Feature Pyramid Network (FPN), a Retina-Net, a Single Shot Detector (SSD), Natural Language processing and (OCR in some cases) typically use networks, such as CNN-recurrent neural network (CNN-RNN), a Long Short-Term Memory (LSTM) network based RNN, LSTM+ANN, hybrid lip-reading (HLR-Net) model, and/or a combination thereof.

The speech-to-text convertor 206 may include suitable logic, circuitry, interfaces and/or code that may be configured to convert audio information in a portion of audio content to text information. In accordance with an embodiment, the speech-to-text convertor 206 may be configured to generate a first text portion based on the speech-to-text analysis of the audio content. The speech-to-text convertor 206 may be implemented based on several processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), and other processors.

The lip movement detector 208 may include suitable logic, circuitry, interfaces and/or code that may be configured to determine lip movements in the video content. In accordance with an embodiment, the lip movement detector 208 may be configured to generate a second text portion based on the analysis of the lip movements in the video content. The lip movement detector 208 may be implemented based on several processor technologies known in the art. Examples of the processor technologies may include, but are not limited to, a Central Processing Unit (CPU), X86-based processor, a Reduced Instruction Set Computing (RISC) processor, an Application-Specific Integrated Circuit (ASIC) processor, a Complex Instruction Set Computing (CISC) processor, a Graphical Processing Unit (GPU), and other processors.

The I/O device 210 may include suitable logic, circuitry, interfaces, and/or code that may be configured to receive an input and provide an output based on the received input. The I/O device 210 may include various input and output devices, which may be configured to communicate with the circuitry 202. In an example, the electronic device 102 may receive (via the I/O device 210) the user input indicative of the user profile associated with the user 114. In an example, the electronic device 102 may display (via the display device 110 associated with the I/O device 210) the generated closed caption. Examples of the I/O device 210 may include, but are not limited to, a touch screen, a keyboard, a mouse, a joystick, a display device (for example, the display device 110), a microphone, or a speaker.

The network interface 212 may include suitable logic, circuitry, interfaces, and/or code that may be configured to facilitate communication between the electronic device 102, the server 104, and the database 106, via the communication network 112. The network interface 212 may be implemented by use of various known technologies to support wired or wireless communication of the electronic device 102 with the communication network 112. The network interface 212 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, or a local buffer circuitry.

The network interface 212 may be configured to communicate via wireless communication with networks, such as the Internet, an Intranet, a wireless network, a cellular telephone network, a wireless local area network (LAN), or a metropolitan area network (MAN). The wireless communication may be configured to use one or more of a plurality of communication standards, protocols and technologies, such as Global System for Mobile Communications (GSM), Enhanced Data GSM Environment (EDGE), wideband code division multiple access (W-CDMA), Long Term Evolution (LTE), code division multiple access (CDMA), time division multiple access (TDMA), Bluetooth, Wireless Fidelity (Wi-Fi) (such as IEEE 802.11a, IEEE 802.11b, IEEE 802.11 g or IEEE 802.11n), voice over Internet Protocol (VoIP), light fidelity (Li-Fi), Worldwide Interoperability for Microwave Access (Wi-MAX), a protocol for email, instant messaging, and a Short Message Service (SMS). Various operations of the circuitry 202 for generation of closed captions based on various visual and non-visual elements in content are described further, for example, in FIGS. 3, 4A, 4B, 4C, 5, and 6.

FIG. 3 is a diagram that illustrates an exemplary processing pipeline for generation of closed captions based on various visual and non-visual elements in content, in accordance with an embodiment of the disclosure. FIG. 3 is explained in conjunction with elements from FIG. 1 and FIG. 2. With reference to FIG. 3, there is shown an exemplary processing pipeline 300 that illustrates exemplary operations from 304 to 312 for generation of closed captions. The exemplary operations may be executed by any computing system, for example, by the electronic device 102 of FIG. 1 or by the circuitry 202 of FIG. 2.

In an operational state, the circuitry 202 may be configured to receive media content 302 from the AV source 108. The media content 302 may include video content 302A and audio content 302B associated with the video content 302A. In an embodiment, the video content 302A may include a plurality of image frames corresponding to a set of scenes included in the media content 302. For example, if the media content 302 is a television program, then the video content 302A may include a performance of character(s) in scenes, a non-verbal reaction of a group of characters in the scene to the performance of the characters, an expression, an action, or a gesture of the character in the scene. Similarly, the audio content 302B may include an interaction between two or more characters in the scene and other audio components, such as audio descriptions, background sound, musical tones, monologue, dialogues, or other non-verbal sounds (such as a laughter sound, a distress sound, a sound produced by objects (such as car, train, buses, or other moveable/immoveable objects), a pleasant sound, an unpleasant sound, a babble noise, or an ambient noise.

At 304, a speech-to-text analysis may be performed on the audio content 302B. In an embodiment, the circuitry 202 may be configured to generate a first text portion based on the speech-to-text analysis. Specifically, the audio content 302B of the received media content 302 may be analyzed and a textual representation of enunciated speech in the received audio content 302B may be extracted using a speech-to-text convertor 206. The generated first text portion may include the extracted textual representation.

In an embodiment, the circuitry 202 may apply a speech-to-text conversion technique to convert the received audio content into a raw text. Thereafter, the circuitry 202 may apply a natural language processing (NLP) technique to process the raw text to generate the first text portion (such as dialogues). Examples of the NLP technique associated with analysis of the raw text may include, but are not limited to, an automatic summarization, a sentiment analysis, a context extraction, a parts-of-speech tagging, a semantic relationship extraction, a stemming, a text mining, and a machine translation. Detailed implementation of such NLP techniques may be known to one skilled in the art; therefore, a detailed description of such techniques has been omitted from the disclosure for the sake of brevity.

At 306, lip movements analysis may be performed. In an embodiment, the circuitry 202 may be configured to generate a second text portion based on the analysis of the lip movements in the video content 302A. In an embodiment, the analysis of the lip movements may be performed based on application of the AI model 214 on the video content 302A. The AI model 214 receive a sequence of image frames (included in the video content 302A) as an input and may detect one or more speakers in each image frame of the sequence of image frames. Further, the AI model 214 may track a position of lips of the detected one or more speakers. Based on the tracking, the AI model 214 may extract lip movement information from the sequence of image frames. In an embodiment, the video content 302A of the received media content 302 may be analyzed using one or more image processing techniques to detect the lip movements and to extract the lip movement information. The AI model 214 may process the lip movement information to generate the second text portion. The second text portion may include dialogues between speakers and other words enunciated or spoken by the one or more speakers in the video content 302A.

At 308, a first text may be generated. In an embodiment, the circuitry 202 may be configured to generate the first text based on at least one of the speech-to-text analysis of the audio content 302B. In an embodiment, the first text may be generated further based on the analysis of the lip movements in the video content 302A. As an example, the generated first text may include the first text portion and the second text portion. Additionally, the generated first text may include markers, such as timestamps and speaker identifiers (for example, names) associated with content of the first text portion and the second text portion. Such timestamps may correspond to a scene and a set of image frames in the video content 302A.

In an embodiment, the circuitry 202 may be configured to compare an accuracy of the first text portion with an accuracy of the second text portion. The accuracy of the first text portion may correspond to an error metric associated with the speech-to-text analysis. For example, the error metric may measure a number of false positive word predictions and/or false negative word predictions against all word predictions or all true positive and true negative word predictions. Detailed implementation of the error metric may be known to one skilled in the art; therefore, a detailed description of the error metric has been omitted from the disclosure for the sake of brevity.

The accuracy of the second text portion may correspond to a confidence of the AI model 214 in a prediction of different words of the second text portion. The confidence may be measured in terms of a percent value between 0% and 100% in generation of the second text portion. A higher accuracy may denote a higher confidence level of the AI model 214. Similarly, a lower accuracy may denote a lower confidence level of the AI model 214. In some embodiments, a threshold accuracy of the first text portion and a threshold accuracy of the second text portion may be set to generate the first text. For example, a first value associated with the accuracy of the first text portion may be 90% and a second value associated with the accuracy of the second text portion may be 80%. Upon comparison of the first value and the second value with a threshold of 85%, the first text may be generated to include only the first text portion.

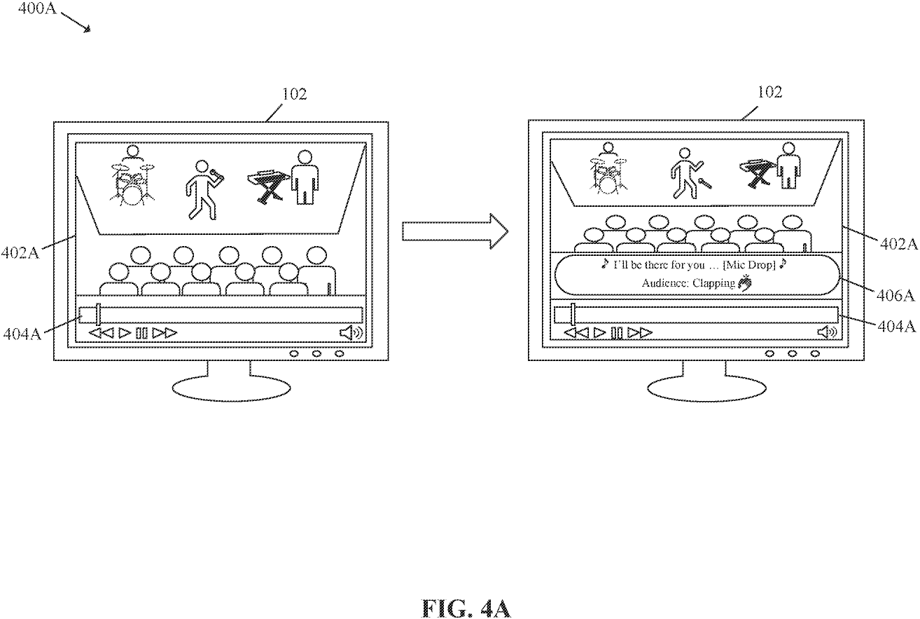

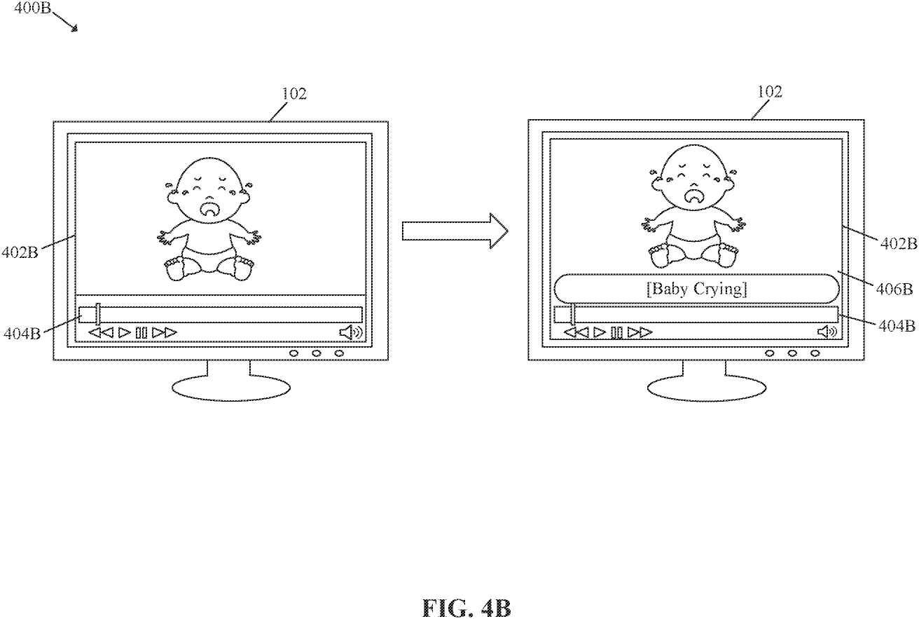

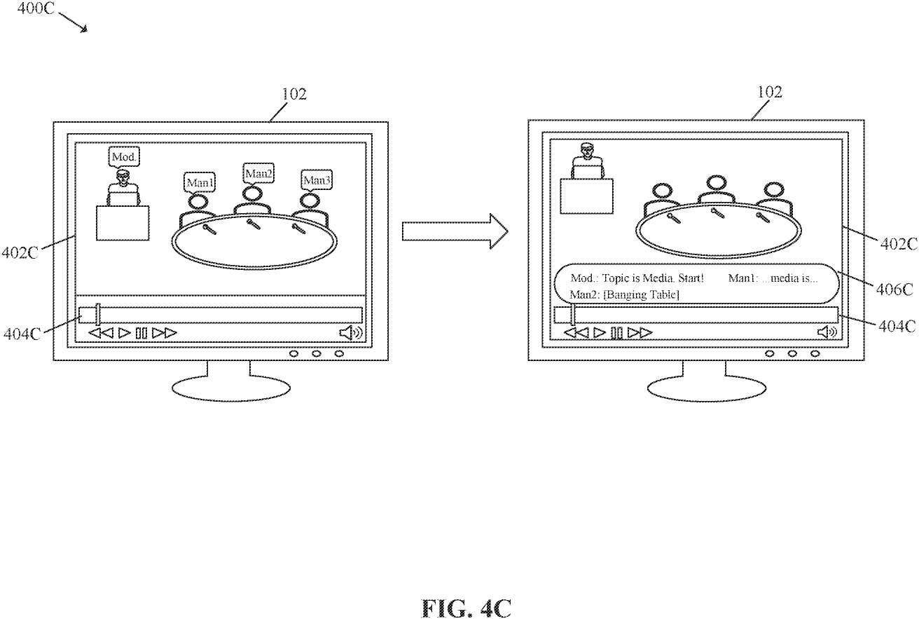

At 310, a second text may be generated. In an embodiment, the circuitry 202 may be configured to generate the second text which describes one or more audio elements of the scene associated with the media content 302. In an embodiment, the second text may be generated based on application of the AI model 214 on the audio content 302B. The one or more audio elements may be different from a speech component of the audio content 302B. As an example, the one or more audio elements may correspond to background sound, musical tones, or other non-verbal sounds (such as a laughter sound, music, a baby crying, a distress sound, a sound produced by objects (such as car, train, buses, or other moveable/immoveable objects), a pleasant sound, an unpleasant sound, a babble noise, or an ambient noise. Different examples related to the one or audio elements are provided, for example, in FIGS. 4A, 4B and 4C.

As shown, for example, the video content 302A may depict a person 314 singing a song, and a drummer. Based on the speech-to-text analysis and the lip movement information, the circuitry 202 may be configured to generate the first text to include a portion “I’ll be there for you...” of the lyrics of the song. Based on the application of the AI model 214 on at least one of the video content 302A or the audio content 302B, the circuitry 202 may be configured to generate the second text that includes musical notes “Drums Beating”.

In accordance with an embodiment, the AI model 214 may be trained to perform analysis of at least one of the video content 302A or the audio content 302B. Based on the analysis, the AI model 214 may be configured to extract scene information from the video content 302A and/or the audio content 302B. The scene information may include, for example, a scene description, scene character identifiers, character actions, object movement, visual or audio-visual events, interaction between objects, character emotions, reactions to events or actions, and the like. The scene information may correspond to visual elements of one or more scenes in the media content 302 and may be used by the AI model 214 to generate a third text.

In an embodiment, the circuitry 202 may be configured to generate the first text and the second text, simultaneously. For instance, the circuitry 202 may be configured to simultaneously perform speech-to text analysis of the audio content 302B and analysis of the one or more audio elements (which are different from the speech component of the audio content 302B) to generate the first text and the second text, respectively. Alternatively, the circuitry 202 may be configured to generate the first text and generate the second text in a sequential manner. For example, the speech-to-text analysis of the audio content 302B may be performed to generate the first text before the second text is generated.

At 312, closed captions may be generated. In an embodiment, the circuitry 202 may be configured to generate the closed captions for the video content 302A, based on the generated first text and the generated second text. The generated closed captions may include dialogues, spoken phrases and words, speaker identifiers for the dialogues and the spoken phrases and words, a description of visual elements in the scenes, and a textual representation of non-verbal sounds in the video content. Such captions may be generated in the same language in which the media content is recorded or in a foreign language. In an embodiment, the generated closed captions may be a transcription, transliteration, or a translation of a dialogue or a phrase spoken in one or more languages for a specific audience. The closed captions may include subtitles for almost every non-speech element (e.g., sound generated by different objects and/or persons other than spoken dialogue of a certain person/character in the media content 302).

In an example, the first text generated based on the speech-to-text analysis and the lip movement analysis may include a dialog “Why must this be” by a character. Within the duration in which the dialog is spoken, the audio element in the scene may correspond to an action or a gesture, such as “speaker banging on a podium”. The circuitry 202 may be configured to generate the closed caption as “Why must this be!”. The exclamation mark may be added to the sentence to emphasize on the strong feeling of the speaker (i.e., the character) in the scene. Another audio element may correspond to an activity of a group of characters, such as students in a lecture hall. The circuitry 202 may be configured to generate the closed caption as “Why must this be?”. The question mark may be added to the sentence to emphasize on a reaction of the students to the action or the gesture of the speaker. In an example, the audio content 404A may include a screaming sound with dialog SHIT with no trailing ‘T’ in the audio. In such a case, the circuitry 202 may generate the closed caption as “Shit!”.

In an embodiment, the circuitry 202 may be configured to determine one or more gaps in the generated first text and insert the generated second text into the detected one or more gaps. Thereafter, the circuitry 202 may be configured to generate the captions based on the insertion of the generated second text in the gaps. For example, the first text generated based on the speech-to-text analysis and the lip movement analysis may include a dialog “Pay Attention” by a character. Within the duration in which the dialog is spoken, the audio element in the scene may correspond to an action or a gesture, such as “speaker banging on a podium”. In such a case, the circuitry 202 may be configured to analyze the generated first text to determine one or more gaps in the generated first text. The generated second text (or a portion of the second text) can be inserted in such gaps to generate the captions for the video content 302A. In cases where the generated second text may correspond to a repetitive sound (for example, a hammering sound, a squeaking sound of birds, and the like), the captions may be generated to include the second text periodically.

In an embodiment, the circuitry 202 may be configured to determine timing information corresponding to the generated first text and the generated second text. The timing information may include respective timestamps at which the speech component and the one or more audio elements (which are different from the speech component) may be detected in the media content. Such information may indicate whether the audio elements are present before, after, or in between the speech component. Thereafter, the circuitry 202 may be configured to generate the captions based on the determined timing information. As an example, if the action or the gesture is made before the dialog, the circuitry 202 may be configured to generate the caption as “[Bang on the podium] Pay Attention!”. If the action or the gesture is made after the dialog, the circuitry 202 may be configured to generate the caption as “Pay Attention! [Bang on the podium]”. If the action or the gesture is made in between the dialog, the circuitry 202 may be configured to generate the caption as “Pay [Bang on the podium] Attention!”.

In an embodiment, the circuitry 202 may be configured to determine the timing information based on the application of the AI model 214 on the generated first text and the generated second text. The AI model 214 may be trained to perform analysis of the generated first text and the generated second text. Based on the analysis, the AI model may be configured to generate the timing information. Thereafter, the circuitry 202 may be configured to generate the closed captions based on the determined timing information. For example, if the media content 302 corresponds to live media content (for example, a live news), then the timing information may allow the circuitry 202 to generate closed captions that effectively line-up with the generated first text and the generated second text.

In an embodiment, the circuitry 202 may be configured to analyze the one or more audio elements of the scene associated with the media content 302 and determine a source of the one or more audio elements as invisible. Thereafter, the circuitry 202 may be configured to generate the closed caption based on a determination that the source of the one or more audio elements is invisible. For example, if the generated second text corresponds to a squealing sound, then the circuitry 202 may be configured to analyze the media content and determine the source of the one or more audio elements. For example, the squealing sound may be associated with a pig, Based on the analysis of the media content 302, it may be determined that the source of the audio element (i.e., the pig) is invisible (i.e., not visible in respective frames rendered on the display device 110). In such a case, the circuitry 202 may include “Pig squealing” as part of the closed captions.

The circuitry 202 may be configured to control a display device 110 associated with the electronic device 102, to display the generated closed captions 316. In an embodiment, the electronic device 102 may apply an AI model or a suitable content recognition model on the received media content to generate information, such as metatags or timestamps to be used to display different components of the generated closed captions on the display device 110 along with the video content 302A.

In an embodiment, the circuitry 202 may be configured to receive a user profile associated with the user 114. The user profile may be indicative of a listening ability of the user 114 or a viewing ability of the user 114. The circuitry 202 may be configured to control the display device 110 to display the generated closed captions 316 further based on the received user profile. For example, the user profile, may include a name, an age, a gender, an extent of listening ability, or an extent of viewing ability of the user 114. The listening ability may indicate an extent of hearing disability of the user 114. In an embodiment, if it is determined that the user 114 suffers from a hearing disability, then the circuitry 202 may be configured to control the display device 110 to display the generated closed captions 316 on the display device 110, without a user input. If it is determined that the user 114 doesn’t have a hearing disability, then the circuitry 202 may be configured to receive a user input indicative of whether the generated closed captions 316 should be displayed on the display device 110. In case the received user input indicates a selection of an option to display the closed captions 316, then the circuitry 202 may be configured to control the display device 110 to display the generated closed captions 316.

The viewing ability may indicate information corresponding to an extent of visual impairment of the user 114. In an embodiment, the circuitry 202 may determine if the user 114 suffers from a visual impairment. Based on such determination, the circuitry 202 may execute a text-to-speech conversion operation on the closed captions 316 to generate an audio. Thereafter, the circuitry 202 may control an audio-reproduction device (not shown) associated with the display device 110 to play the audio.

In an embodiment, the AI model 214 may be trained to determine an accuracy of the first text with respect to an accuracy of the second text. In some scenarios, while generating the first text portion, the speech-to-text convertor 206 may miss out on correct analysis of certain portions of the audio content 302B. This may be due to several factors, such as a heavy accent or a non-native accent associated with certain portions of the audio content 302B or a background noise in such portions of the audio content 302B. In such scenarios, the second text portion (corresponding to the lip movements analysis) may be used to correct and improve the content of the first text. Further, the second text may include a description of certain visual elements which are otherwise not captured in the first text. The second text may further enrich content of the first text and the closed captions 316.

FIG. 4A is a diagram that illustrates an exemplary scenario for generation of closed captions based on various visual and non-visual elements in content, in accordance with an embodiment of the disclosure. FIG. 4A is described in conjunction with elements from FIGS. 1, 2, and 3. With reference to FIG. 4A, there is shown a scenario 400A. The scenario 400A may include an electronic device 102. There is shown a scene of the media content displayed on the display device 110 associated with the electronic device 102. The scene depicts a concert. A set of operations associated the scenario 400A is described herein.

The circuitry 202 may be configured to receive the media content that includes video content 402A and audio content 404A associated with the video content 402A. The video content 402A may include a set of scenes. As shown, for example, one of the scenes may depict a concert and may include a performance of one or more characters. The scene may also include a group of characters as part of an audience for the performance.

The circuitry 202 may be configured to generate a first text based on a speech-to-text analysis of the audio content 404A, as described, for example, at 304 in FIG. 3. In an embodiment, the first text may be generated further based on the analysis of the lip movements in the video content 402A, as described, for example, at 306 in FIG. 3. The circuitry 202 may be further configured to generate a second text which describes one or more audio elements of the scene(s) associated with the media content. The one or more audio elements may be different from a speech component of the audio content 404A. As shown, for example, there may be one or more audio elements corresponding to a concert (i.e., an event). A first audio element may include an action of a character in the scene, such as singing, drums beating, and playing a piano in the scene. A second audio element may include a gesture of the character, such as a mic drop by the singer in the scene. A third audio element may include a non-verbal reaction, such as an act of clapping by a group of people as a response to the performance of the singer or other performers.

The circuitry 202 may be configured to generate the closed captions for the video content 402A, based on the generated first text and the generated second text. The circuitry 202 may be further configured to control the display device 110 associated with the electronic device 102, to display the generated closed captions, as described, for example, at 312 in FIG. 3. As an example, shown in FIG. 4A, the generated closed captions 406A may be depicted as “(musical note) I’ll be there for you... [mic drop] (musical note)”, “Audience: clapping (clap icon)”.

In an embodiment, the circuitry 202 may be configured to generate a third text based on application of an Artificial Intelligence (AI) model (such as the AI model 214) on the video content 402A. The AI model may be applied to analyze one or more visual elements of the video content 402A that may be different from the lip movements. Examples of the one or more visual elements may include, but are not limited to, one or more events associated with a performance of a character in the scene, an expression, an action, or a gesture of the character in the scene, an interaction between two or more characters in the scene, an activity of a group of characters in the scene, a non-verbal reaction, such as an act of clapping by a group of people as a response to the performance of the singer or other performers, or a distress call.

For example, the one or more visual elements may correspond to one or more events (such as a fall from cliff) associated with a performance of a character (such as a person) in the scene. As shown, for example, there may be one or more visual elements corresponding to a concert (i.e., an event). A first visual element may include a performance of a character in the scene, such as a performance by a singer, a drummer, and a pianist in the scene. A second visual element may include an expression, an action, or a gesture of the character, such as a mic drop by the singer in the scene. A third visual element may include a non-verbal reaction of the group of characters such as, clapping by the audience in the scene as a response to the performance of the characters. The third text may include word(s), sentence(s), or phrase(s) that describe or label such visual elements.

FIG. 4B is a diagram that illustrates an exemplary scenario for generation of closed captions based on various visual and non-visual elements in content, in accordance with an embodiment of the disclosure. FIG. 4B is described in conjunction with elements from FIGS. 1, 2, 3, and 4A. With reference to FIG. 4B, there is shown a scenario 400B that includes an electronic device 102. There is further shown a scene of media content displayed on the display device 110 associated with the electronic device 102. The scene includes one or more characters, such as a crying baby. A set of operations associated the scenario 400B is described herein.

The circuitry 202 may be configured to receive the media content that includes video content 402B and audio content 404B associated with the video content 402B. The video content 402B may include one or more audio elements corresponding to an action performed by the character. As shown, for example, the action may include an activity (i.e., crying) performed by the baby.

In an embodiment, the circuitry 202 may be configured to detect an audio element in the received media content, based on the analysis of the audio content 404B. For example, the analysis may include application of the AI model 214 on the audio content 404B to extract an audio segment from the audio content 404B that includes a sound produced by the baby. The AI model 214 may also generate a label to identify the sound as a crying sound produced by the baby. The AI model 214 may be trained for detection and identification of the one or more audio elements in the received media content.

In an embodiment, the circuitry 202 may be configured to generate the closed captions for the video content 402B, based on the generated first text and the generated second text. The circuitry 202 may control the display device 110 associated with the electronic device 102, to display the generated closed captions, as described, for example, at 312 in FIG. 3. As an example, shown in FIG. 4B, the generated closed captions 406B may be depicted as “[Baby Crying].” In some instances, the one or more audio elements may correspond to one or more events, such as an explosion, music from a radio, or sound from the train in the scene.

FIG. 4C is a diagram that illustrates an exemplary scenario for generation of closed captions based on various visual and non-visual elements in content, in accordance with an embodiment of the disclosure. FIG. 4C is described in conjunction with elements from FIGS. 1, 2, 3, 4A, and 4B. With reference to FIG. 4C, there is shown a scenario 400C. The scenario 400C may include an electronic device 102. There is shown a scene of the media content displayed on the display device 110 associated with the electronic device 102. The scene includes a group of speakers. A set of operations associated the scenario 400C is described herein.

The circuitry 202 may be configured to receive the media content that includes video content 402C and audio content 404C associated with the video content 402C. The video content 402C may include one or more visual elements corresponding to an interaction between two or more characters. As shown, for example, the interaction may include an activity (i.e., a group discussion) between characters in the scene.

In an embodiment, the circuitry 202 may be configured to detect a plurality of speaking characters in the received media content, based on at least one of the analysis of the lip movements in the video content 402B and a speech-based speaker recognition. The plurality of speaking characters may correspond to one or more characters of the scene. In an embodiment, the circuitry 202 may be configured to detect the plurality of speaking characters in the received media content, based on the application of the AI model 214. The AI model 214 may be trained for detection and identification of the plurality of speaking characters in the received media content.

The circuitry 202 may be configured to generate a set of tags based on the detection. Each tag of the set of tags may correspond to an identifier for one of the plurality of speaking characters. For example, the generated set of tags may include “Man 1”, “Man 2”, “Man 3”, “Man 4”, and “Mod” for a first person, a second person, a third person, and a moderator of the group discussion, respectively, in the scene. Alternatively, the tags may include a name of each character, such as the first person, the second person, the third person, and the moderator of the group discussion.

In an embodiment, the circuitry 202 may be configured to control the display device 110 to display the set of tags close to a respective location of the plurality of speakers in the scene. For example, the tags may be displayed closed to a head of the speaker. The circuitry 202 may be configured to update the closed captions so as to associate each portion of the closed captions with a corresponding tag of the set of tags. As an example, shown in FIG. 4C, the generated closed captions 406C may be depicted as “Mod: Topic is Media. Start!” “Man 1: ...media is...” “Man 2: [Banging Table]”

In an example, the circuitry 202 may be configured to color code the detected plurality of speaking characters. for example, captions corresponding to Man 1 may be displayed in Red color, captions corresponding to Man 2 may be displayed in Yellow color, captions corresponding to Man 3 may be displayed in Green color, and captions corresponding to Mod may be displayed in Orange color.

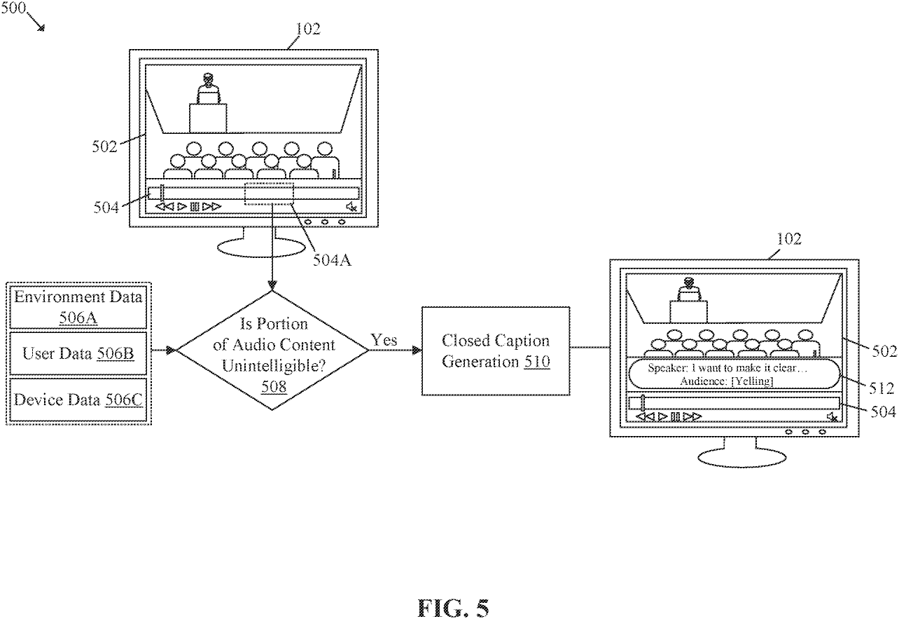

FIG. 5 is a diagram that illustrates an exemplary scenario for generation of closed captions when a portion of audio content is unintelligible, in accordance with an embodiment of the disclosure. FIG. 5 is described in conjunction with elements from FIGS. 1, 2, 3, 4A, 4B, and 4C. With reference to FIG. 5, there is shown an exemplary scenario 500. The exemplary scenario 500 may include an electronic device 102. There is shown a scene of the media content displayed on the display device 110 associated with the electronic device 102. The operations to generate closed captions when a portion of audio content is unintelligible is described herein.

The circuitry 202 may be configured to receive the media content that includes video content 502 and audio content 504 associated with the video content 502, as described, for example, in FIG. 3. The video content 502 may depict a set of scenes. As shown, for example, one of the scenes includes a speaker standing close to a podium and addressing an audience.

At 508, an unintelligible portion of the audio content may be determined. In an embodiment, the circuitry 202 may be configured to determine a portion 504A of the audio content 504 as unintelligible. The portion 504A of the audio content 504 may be determined as unintelligible based on factors, such as a determination that the portion 504A of the audio content 504 is missing a sound, a determination that the speech-to-text analysis failed to interpret speech in the audio content to a threshold level of certainty, a hearing disability or a hearing loss of a user 114 associated with the electronic device 102, an accent of a speaker associated with the portion 504A of the audio content 504, a loud sound or a noise in a background of an environment that includes the electronic device 102, a determination that the electronic device 102 is on mute, an inability of the user 114 to hear sound at certain frequencies, and a determination that the portion 504A of the audio content 504 is noisy.

By way of example, and not limitation, the portion 504A of the audio content 504 may be missing from the audio content 504. As a result, the portion 504A of the audio content 504 may be unintelligible to the user 114. Without the portion 504A, it may not be possible to generate a first text portion, based on a speech-to-text analysis of for the portion 504A. In some instances, it is possible that lips of the speaking character are not visible due to occlusion by certain objects in the scene or due to an orientation of the speaking character (for example, only the back of the speaking character is visible in the scene). In such instances, it may not be possible to generate a second text portion, based on a lip movements analysis.

In an embodiment, the circuitry 202 may fail to interpret speech in the portion 504A of the audio content 504 (while performing the speech-to-text analysis) to a threshold level of certainty. For example, the threshold level of certainty may be 60%, 70%, 75%, or any other value between 0% and 100%. Based on the failure, the portion 504A of the audio content 504 may be determined as unintelligible for the user 114.

In an embodiment, the accent of a speaker associated with the portion 504A of the audio content 504 may be unintelligible to the user 114. For example, the speaker may speak English with a French accent or a very heavy accent, and the user 114 may be a British or American, who may be accustomed to British or American accent. The user 114 may, at times, find it difficult to understand the speech of the speaker. As another example, the portion 504A of the audio content 504 may be noisy. For example, the audio content 504 may be recorded around a group of people who may be waiting next to a train track. The audio content may include a train noise, a babble noise due to various speaking characters in background, train announcements, and the like. Such noises may make the portion 504A of the audio content as unintelligible.

In accordance with an embodiment, the portion 504A of the audio content 504 may be determined as unintelligible based on an environment data 506A, a user data 506B, and a device data 506C. The environment data 506A may include information on a loud sound or a noise in the background of the environment that includes the electronic device 102. The user data 506B may include information associated with the user 114. For example, the user data 506B may be stored in the user profile associated with the user 114. The user profile may be indicative of a hearing disability or a hearing loss of the user 114 associated with the electronic device 102 and of the inability of the user 114 to hear sound at certain frequencies. The device data 506C may include information associated with the electronic device 102. For example, the device data 506C may include the information on whether the electronic device 102 is on mute or not. Such information may be indicated on the display device 110 by a mute option.

In an embodiment, the circuitry 202 may configured to determine the portion 504A of the audio content 504 as unintelligible based on application of the AI model 214 on the audio content 504. For example, the circuitry 202 may fail to generate the first text for a portion (e.g., the portion 504A) of the audio content 504, based on a speech-to-text analysis of the audio content 504. The circuitry 202 may be configured to apply the AI model 214 on the portion 504A of the audio content 504 to include a text such as “Indistinct Conversation”, “Conversation cannot be distinguished” or “Indeterminate conversation” in the first text (i.e., a part of the closed captions),

At 510, closed captions may be generated. In an embodiment, the circuitry 202 may be configured to generate the closed captions based on a determination that the portion of the audio content is unintelligible. The closed captions may be generated to include the generated first text and the generated second text in a defined format.

As described in FIG. 3, the first text may be generated based on at least one of the speech-to-text analysis of the audio content 504 and/or the analysis of the lip movements in the video content 502. The second text may be generated based on the application of the AI model 214 and may describe one or more audio elements of the scene associated with the media content.

The circuitry 202 may be configured to control the display device 110 associated with the electronic device 102, to display the generated closed captions, as described, for example, at 312 in FIG. 1 and FIG. 3. As an example, shown in FIG. 5, the generated closed captions 512 may be depicted as “Speaker: I want to make it clear..., Audience: [Yelling]”.

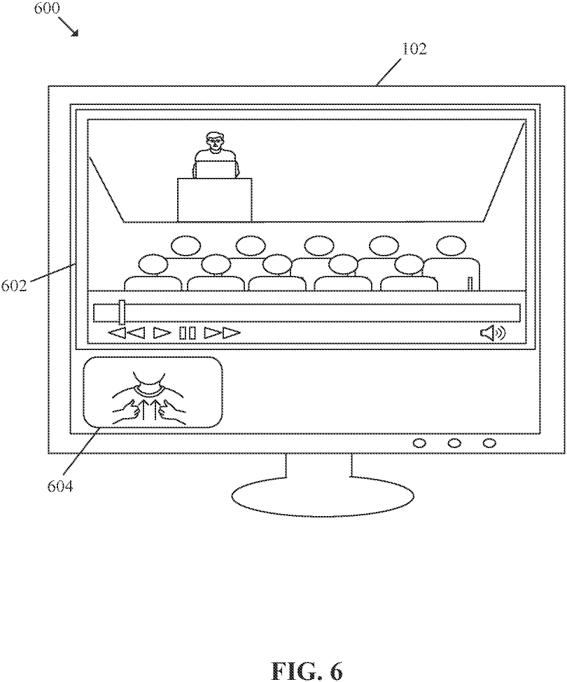

FIG. 6 is a diagram that illustrates an exemplary scenario for generation of hand-sign symbols based on various visual and non-visual elements in content, in accordance with an embodiment of the disclosure. FIG. 6 is described in conjunction with elements from FIGS. 1, 2, 3, 4A, 4B, 4C, and 5. With reference to FIG. 6, there is shown an exemplary scenario 600. The exemplary scenario 600 may include an electronic device 102. There is shown a scene of the media content displayed on the display device 110 associated with the electronic device 102. The operations to generate hand-sign symbols based on various visual and non-visual elements is described herein.

The circuitry 202 may be configured to receive the media content 602 that includes video content and audio content associated with the video content, as described, for example, in FIG. 3. The video content may include a set of scenes. As shown, for example, one of such scenes include a speaker standing close to a podium and addressing an audience.

The circuitry 202 may be configured to generate a first text based on at least one of the speech-to-text analysis of the audio content and the analysis of the lip movements in the video content, as described, for example, at 308 in FIG. 3. The circuitry 202 may be further configured to generate a second text which describes one or more visual elements of the scene associated with the media content 602, based on the application of the AI model 214, as described, for example, at 310 in FIG. 3. The circuitry 202 may be configured to generate the closed captions for the video content, based on the generated first text and the generated second text.

In an embodiment, the circuitry 202 may be configured to determine a hearing disability or hearing loss of the user 114 associated with the electronic device 102 or an inability of the user 114 to hear sound at certain frequencies based on the received user profile associated with the user 114. In such a case, the circuitry 202 may be configured to generate captions that include hand-sign symbols associated with a sign language, such as American Sign Language (ASL). The captions that include the hand-sign symbols may be generated based on the generated first text and the generated second text. The display device 110 may be controlled to display the generated captions along with the video content. An example of the generated closed captions 604 is shown.

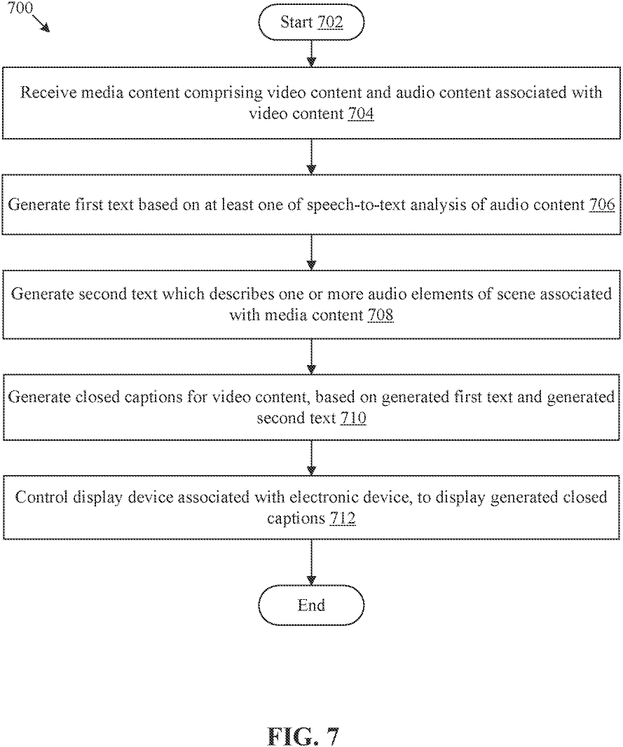

FIG. 7 is a flowchart that illustrates exemplary operations for generation of closed captions based on various visual and non-visual elements in content, in accordance with an embodiment of the disclosure. FIG. 7 is described in conjunction with elements from FIGS. 1, 2, 3, 4A, 4B, 5, and 6. With reference to FIG. 7, there is shown a flowchart 700. The flowchart 700 may include operations from 702 to 712 and may be implemented by the electronic device 102 of FIG. 1 or by the circuitry 202 of FIG. 2. The flowchart 700 may start at 702 and proceed to 704.

At 704, media content including video content and audio content associated with the video content may be received. In an embodiment, the circuitry 202 may be configured to receive the media content (for example, the media content 302) including video content (for example, the video content 302A) and audio content (for example, the audio content 302B) associated with the video content 302A. The reception of the media content 302 is described, for example, in FIG. 3.

At 706, a first text may be generated, based on at least one of a speech-to-text analysis of the audio content, and analysis of lip movements in the video content. In an embodiment, the circuitry 202 may be configured to generate the first text based on at least of the speech-to-text analysis of the audio content 302B, and the analysis of lip movements in the video content 302A. The generation of the first text is described, for example, at 308 in FIG. 3.

At 708, a second text which describes one or more audio elements of a scene associated with the media content may be generated. In an embodiment, the circuitry 202 may be configured to generate the second text which describes the one or more audio elements of the scene. The one or more audio elements may be different from a speech component of the audio content 302B. The generation of the second text is described, for example, at 310 in FIG. 3.

At 710, closed captions for the video content may be generated, based on the generated first text and the generated second text. In an embodiment, the circuitry 202 may be configured to generate the closed captions (for example, the closed captions 316) for the video content 302A, based on the generated first text and the generated second text. The generation of the closed captions 316 is described, for example, in FIG. 3.

At 712, a display device associated with the electronic device may be controlled, to display the generated closed captions. In an embodiment, the circuitry 202 may be configured to control the display device (for example the display device 110) associated with the electronic device 102, to display the generated closed captions. The control of the display device 110 is described, for example, in FIG. 3. Control may pass to end.

Although the flowchart 700 is illustrated as discrete operations, such as 704, 706, 708, 710, and 712, the disclosure is not so limited. Accordingly, in certain embodiments, such discrete operations may be further divided into additional operations, combined into fewer operations, or eliminated, depending on the implementation without detracting from the essence of the disclosed embodiments.

Various embodiments of the disclosure may provide a non-transitory computer-readable medium and/or storage medium having stored thereon, computer-executable instructions executable by a machine and/or a computer to operate an electronic device (for example, the electronic device 102). Such instructions may cause the electronic device 102 to perform operations that include retrieval of media content (for example, the media content 302) including video content (for example, the video content 302A) and audio content (for example, the audio content 302B) associated with the video content 302A. The operations may further include generate a first text based on at least one of a speech-to-text analysis of the audio content 302B. The operations may further include generation a second text which describes one or more audio elements of a scene associated with the media content 302. The one or more audio elements may be different from a speech component of the audio content 302B. The operations may further include generation of closed captions (for example, the closed captions 316) for the video content 302A, based on the generated first text and the generated second text. The operations may further include control of a display device (for example, the display device 110) associated with the electronic device 102, to display the generated closed captions 316.

Exemplary aspects of the disclosure may provide an electronic device (such as, the electronic device 102 of FIG. 1) that includes circuitry (such as, the circuitry 202). The circuitry 202 may be configured to receive media content (for example, the media content 302) including video content (for example, the video content 302A) and audio content (for example, the audio content 302B) associated with the video content 302A. The circuitry 202 may be further configured to generate a first text based on at least one of a speech-to-text analysis of the audio content 302B. The circuitry 202 may be further configured to generate a second text which describes one or more audio elements of a scene associated with the media content 302. The one or more audio elements may be different from a speech component of the audio content 302B. The circuitry 202 may be further configured to generate closed captions (for example, the closed captions 316) for the video content 302A, based on the generated first text and the generated second text. The circuitry 202 may be further configured to control a display device (for example, the display device 110) associated with the electronic device 102, to display the generated closed captions 316.

In an embodiment, the received media content 302 may be a pre-recorded media content or a live media content.

In an embodiment, the first text is generated further based on an analysis of lip movements in the video content 302A.

In an embodiment, the analysis of the lip movements may be based on application of the AI model 214 on the video content 302A.

In an embodiment, the generated first text may include a first text portion that is generated based on the speech-to-text analysis, and a second text portion that is generated based on the analysis of the lip movements.

In an embodiment, the circuitry 202 may be configured to compare an accuracy of the first text portion with an accuracy of the second text portion. The circuitry 202 may be further configured to generate the closed captions 316 based on the comparison.

In an embodiment, the accuracy of the first text portion may correspond to an error metric associated with the speech-to-text analysis, and the accuracy of the second text portion may correspond to a confidence of the AI model 214 in a prediction of different words of the second text portion.

In an embodiment, the circuitry 202 may be configured to generate a third text based on application of an AI model (such as the AI model 214) on the video content 302A to analyze one or more visual elements of the video content that are different from the lip movements.

In an embodiment, the one or more visual elements correspond to at least one of one or more events associated with a performance of a character in the scene, an expression, an action, or a gesture of the character in the scene, an interaction between two or more characters in the scene, an activity of a group of characters in the scene, a non-verbal reaction of the group of characters in the scene to the performance of the character, and a distress call.

In an embodiment, the circuitry 202 may be configured to determine a portion (for example, the portion 504A) of the audio content (for example, the audio content 504) as unintelligible. The circuitry 202 may be further configured to generate the closed captions (for example, the closed captions 512) further based on the determination that the portion 504A of the audio content 504 is unintelligible.

In an embodiment, the portion 504A of the audio content 504 is determined as unintelligible based on at least one of a determination that the portion 504A of the audio content 504 is missing a sound, a determination that the speech-to-text analysis failed to interpret speech in the audio content 504 to a threshold level of certainty, a hearing disability or a hearing loss of a user 114 associated with the electronic device 102, an accent of a speaker associated with the portion 504A of the audio content 504, a loud sound or a noise in a background of an environment that includes the electronic device 102, a determination that the electronic device 102 is on mute, an inability of the user 114 to hear sound at certain frequencies, and a determination that the portion 504A of the audio content 504 is noisy.

In an embodiment, the circuitry 202 may be configured to generate captions (for example, the captions 604) that include hand-sign symbols associated with a sign language, based on the generated first text and the generated second text. The circuitry 202 may be further configured to control the display device 110 to display the generated captions.

In an embodiment, the circuitry 202 may be further configured to receive a user profile associated with the user 114. The user profile may be indicative of a listening ability of the user or a viewing ability of the user 114. The circuitry 202 may be further configured to control the display device 110 to display the generated closed captions 316 further based on the received user profile.

In an embodiment, the circuitry 202 may be further configured to detect a plurality of speaking characters in the received media content 302, based on at least one of the analysis of the lip movements in the video content 302A, and a speech-based speaker recognition. The circuitry 202 may be configured to generate a set of tags based on the detection. Each tag of the set of tags may correspond to an identifier of one of the plurality of speaking characters. the circuitry 202 may be configured to update the closed captions to associate each portion of the closed captions with a corresponding tag of the set of tags.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with information processing capability to perform a particular function either directly, or after either or both of the following: a) conversion to another language, code or notation; b) reproduction in a different material form.

While the present disclosure is described with reference to certain embodiments, it will be understood by those skilled in the art that various changes may be made, and equivalents may be substituted without departure from the scope of the present disclosure. In addition, many modifications may be made to adapt a particular situation or material to the teachings of the present disclosure without departure from its scope. Therefore, it is intended that the present disclosure is not limited to the embodiment disclosed, but that the present disclosure will include all embodiments that fall within the scope of the appended claims.

What is claimed is:

1. An electronic device, comprising:
circuitry configured to:
receive media content comprising video content and audio content associated with the video content;
generate a first text based on a speech-to-text analysis of the audio content;
generate a second text which describes one or more audio elements of a scene associated with the media content,
wherein the one or more audio elements are different from a speech component of the audio content;
generate closed captions for the video content, based on the generated first text and the generated second text; and
control a display device associated with the electronic device, to display the generated closed captions.

2. The electronic device according to claim 1, wherein the received media content is a pre-recorded media content or a live media content.

3. The electronic device according to claim 1, wherein the first text is generated further based on an analysis of lip movements in the video content.

4. The electronic device according to claim 3, wherein the analysis of the lip movements is based on application of an Artificial Intelligence (AI) model on the video content.

5. The electronic device according to claim 4, wherein the generated first text comprises:
a first text portion that is generated based on the speech-to-text analysis, and
a second text portion that is generated based on the analysis of the lip movements.

6. The electronic device according to claim 5, wherein the circuitry is further configured to:
compare an accuracy of the first text portion with an accuracy of the second text portion; and
generate the closed captions further based on the comparison.

7. The electronic device according to claim 6, wherein the accuracy of the first text portion corresponds to an error metric associated with the speech-to-text analysis and,
the accuracy of the second text portion corresponds to a confidence of the AI model in a prediction of different words of the second text portion.

8. The electronic device according to claim 1, wherein the circuitry is further configured to generate a third text based on application of an Artificial Intelligence (AI) model on the video content, and the AI model is applied to analyze one or more visual elements of the video content that are different from lip movements in the video content.

9. The electronic device according to claim 8, wherein the one or more visual elements correspond to at least one of:
one or more events associated with a performance of a character in the scene,
an expression, an action, or a gesture of the character in the scene,
an interaction between two or more characters in the scene,
an activity of a group of characters in the scene,
a non-verbal reaction of the group of characters in the scene to the performance of the character, and a distress call.

10. The electronic device according to claim 1, wherein the circuitry is further configured to:
determine a portion of the audio content as unintelligible; and
generate the closed captions further based on the determination that the portion of the audio content is unintelligible.

11. The electronic device according to claim 10, wherein the portion of the audio content is determined as unintelligible based on at least one of:
a determination that the portion of the audio content is missing a sound,
a determination that the speech-to-text analysis failed to interpret speech in the audio content to a threshold level of certainty,
a hearing disability or a hearing loss of a user associated with the electronic device,
an accent of a speaker associated with the portion of the audio content,
a loud sound or a noise in a background of an environment that includes the electronic device,
a determination that the electronic device is on mute,
an inability of the user to hear sound at certain frequencies, and
a determination that the portion of the audio content is noisy.

12. The electronic device according to claim 1, wherein the circuitry is further configured to:
generate captions that include hand-sign symbols associated with a sign language, based on the generated first text and the generated second text; and
control the display device to display the generated captions.

13. The electronic device according to claim 1, wherein the circuitry is further configured to:
receive a user profile associated with a user, wherein the user profile is indicative of a listening ability of the user or a viewing ability of the user; and
control the display device to display the generated closed captions further based on the received user profile.

14. The electronic device according to claim 1, wherein the circuitry is further configured to:
detect a plurality of speaking characters in the received media content, based on at least one of:
the analysis of lip movements in the video content, and
a speech-based speaker recognition;
generate a set of tags based on the detection, wherein each tag of the set of tags corresponds to an identifier of one of the plurality of speaking characters; and
update the closed captions to associate each portion of the closed captions with a corresponding tag of the set of tags.

15. The electronic device according to claim 1, wherein the circuitry is further configured to:
determine one or more gaps in the generated first text;
insert the generated second text based on the detected one or more gaps; and
generate the closed captions further based on the insertion of the generated second text.

16. The electronic device according to claim 1, wherein the circuitry is further configured to:
analyze the one or more audio elements of the scene associated with the media content;
determine a source of the one or more audio elements as invisible; and
generate the closed captions further based on the determination that the source of the one or more audio elements is invisible.

17. The electronic device according to claim 1, wherein the circuitry is further configured to:
determine timing information corresponding to the generated first text and the generated second text; and
generate the closed captions further based on the determined timing information.

18. A method, comprising: in an electronic device:
receiving media content comprising video content and audio content associated with the video content;
generating a first text based on a speech-to-text analysis of the audio content;
generating a second text which describes one or more audio elements of a scene associated with the media content,
wherein the one or more audio elements are different from a speech component of the audio content;
generating closed captions for the video content, based on the generated first text and the generated second text; and
controlling a display device associated with the electronic device, to display the generated closed captions.

19. The method according to claim 15, wherein the first text is generated further based on an analysis of lip movements in the video content.

20. The method according to claim 16, wherein the analysis of the lip movements is based on application of an Artificial Intelligence (AI) model on the video content.

21. The method according to claim 15, further comprising generating a third text based on application of an Artificial Intelligence (AI) model on the video content, and the AI model is applied to analyze one or more visual elements of the video content that are different from lip movements in the video content.

22. The method according to claim 18, wherein the one or more visual elements correspond to at least one of:
one or more events associated with a performance of a character in the scene, an expression, an action, or a gesture of the character in the scene,
an interaction between two or more characters in the scene,
an activity of a group of characters in the scene, or
a non-verbal reaction of the group of characters in the scene to the performance of the character, and a distress call.

23. A non-transitory computer-readable medium having stored thereon, computer-executable instructions that when executed by an electronic device, causes the electronic device to execute operations, the operations comprising:
receiving media content comprising video content and audio content associated with the video content;
generating a first text based on a speech-to-text analysis of the audio content;
generating a second text which describes one or more audio elements of a scene associated with the media content,
wherein the one or more audio elements are different from a speech component of the audio content;
generating closed captions for the video content, based on the generated first text and the generated second text; and
controlling a display device associated with the electronic device, to display the generated closed captions.
